(19) United States
(12) Patent Application Publication
(10) Pub. No.: US 2013/0197816 A1
(43) Pub. Date: Aug. 1, 2013

(54) CALIBRATION CURVE CREATION METHOD, CALIBRATION CURVE CREATION DEVICE AND TARGET COMPONENT DETERMINATION DEVICE

(71) Applicants: Hikaru KURASAWA, Fujimi-machi (JP); Yoshifumi ARAI, Matsumoto-shi (JP)

(72) Inventors: Hikaru KURASAWA, Fujimi-machi (JP); Yoshifumi ARAI, Matsumoto-shi (JP)

(73) Assignee: SEIKO EPSON CORPORATION, Tokyo (JP)

(21) Appl. No.: 13/534,621

(22) Filed: Jun. 27, 2012

(30) Foreign Application Priority Data
Jan. 30, 2012 (JP) 2012-16854

(51) Int. Cl. G06F 19/00

(52) U.S. Cl. 702/27

(57) ABSTRACT

A method sequentially obtains observation data with respect to a plurality of samples for a test subject and obtains content of a target component contained in each of the plurality of samples. The method subsequently estimates a plurality of independent components, which are separated from the observation data with respect to each of the samples, and calculates a mixing coefficient corresponding to the target component with respect to each of the samples, based on the estimated plurality of independent components. The method then determines a regression equation of a calibration curve, based on the obtained contents of the target component contained in the plurality of samples and the mixing coefficients of the respective samples.

### CROSS REFERENCE TO RELATED APPLICATIONS

The present application claims the priority based on Japanese Patent Application No. 2012-16854 filed on Jan. 30, 2012, the disclosures of which is hereby incorporated by reference in its entirety.

### BACKGROUND

1. Technical Field

The present invention relates to creating a calibration curve for use in determining the content of a target component contained in a test subject and determining the content of the target component contained in the test subject from observed data of the test subject.

2. Description of the Related Art

One prior art method performs independent component analysis with respect to observation data obtained for a test subject from a plurality of different locations, sets independent components calculated by the independent component analysis as base functions, and expresses the observation data as a linear sum of the base functions, so as to analyze the concentration of a target component.

The prior art method, however, requires a plurality of different observation data with respect to the test subject for determination of the target component contained in the test subject. The content of the target component is thus not determinable with high accuracy from single observation data.

### SUMMARY

Consequently, by taking into account the above problems, there is a need to enable highly accurate determination of a target component contained in a test subject from single observation data of the test subject.

In order to achieve at least part of the foregoing, the present invention provides various aspects and embodiments described below.

According to a first aspect of the invention, there is provided a method of creating a calibration curve for use in determining content of a target component contained in a test subject from observation data of the test subject. The method includes the steps of: obtaining observation data with respect to a plurality of samples of the test subject; and obtaining content of the target component contained in each of the plurality of samples. The method subsequently includes the steps of: estimating a plurality of independent components, which are separated from the observation data with respect to each of the samples, and calculating a mixing coefficient corresponding to the target component with respect to each of the samples, based on the estimated plurality of independent components; and determining a regression equation of the calibration curve, based on the obtained contents of the target component contained in the plurality of samples and the mixing coefficients for the respective samples.

The method according to the first aspect creates the calibration curve, which is used to determine the content of the target component contained in the test subject from the observation data of the test subject, based on the obtained observation data of the plurality of samples for the test subject and the contents of the target component contained in the respective samples. Using this calibration curve enables the content of the target component contained in the test subject to be determined with high accuracy even there is only single observation data of the test subject. Creating the calibration curve in advance according to the method according to the first aspect requires only single observation data of the test subject for determination of the target component. The content of the target component contained in the target component can thus be determined with high accuracy from the single observation data provided as the actually measured data.

According to one embodiment, there is provided the method of the first aspect, wherein the step of estimating a plurality of independent components and calculating the mixing coefficient includes: calculating an independent component matrix consisting of the independent components with respect to each of the samples; calculating an estimated mixing matrix representing a set of vectors, which defines rates of independent component elements for the independent components with respect to each of the samples, from the independent component matrix; and determining correlations of the respective vectors included in the estimated mixing matrix to the contents of the target component contained in the plurality of samples, and selecting a vector determined to have highest correlation among the set of vectors, as the mixing coefficient corresponding to the target component.

The method according to this embodiment sequentially calculates the independent component matrix and the estimated mixing matrix and selects the vector as the element of the estimated mixing matrix having the highest correlation to the contents of the target component contained in the plurality of samples. This provides the mixing coefficient with the high estimation accuracy.

According to a second aspect of the invention, there is provided a calibration curve creation device configured to create a calibration curve for use in determining content of a target component contained in a test subject from observation data of the test subject. The calibration curve creation device comprises: a sample observation data acquirer configured to obtain observation data with respect to a plurality of samples of the test subject; a sample target component content acquirer configured to obtain content of the target component contained in each of the plurality of samples; a mixing coefficient estimator configured to estimate a plurality of independent components, which are separated from the observation data with respect to each of the samples, and to calculate a mixing coefficient corresponding to the target component with respect to each of the samples, based on the estimated plurality of independent components; and a regression equation determiner configured to determine a regression equation of the calibration curve, based on the obtained contents of the target component contained in the plurality of samples and the mixing coefficients for the respective samples.

Like the method of the first aspect described above, creating the calibration curve in advance by the calibration curve creation device of the second aspect requires only single observation data of the test subject for determination of the target component. The content of the target component contained in the target component can thus be determined with high accuracy from the single observation data provided as the actually measured data.

According to one embodiment, there is provided the calibration curve creation device of the second aspect, wherein the mixing coefficient estimator may comprise: an independent component matrix calculator configured to calculate an independent component matrix consisting of the independent components with respect to each of the samples; an estimated mixing matrix calculator configured to calculate an estimated mixing matrix representing a set of vectors, which defines rates of independent component elements for the independent components with respect to each of the samples, from the independent component matrix; and a mixing coefficient selector configured to determine correlations of the respective vectors included in the estimated mixing matrix to the contents of the target component contained in the plurality of samples and to select a vector determined to have highest correlation among the set of vectors, as the mixing coefficient corresponding to the target component.

This configuration provides the mixing coefficient with the high estimation accuracy.

According to another embodiment, there is provided the calibration curve creation device of the second aspect, which may further comprise a storage unit configured to store the independent component matrix calculated by the independent component matrix calculator, a target component ordinal number representing a position in the estimated mixing matrix where the mixing coefficient selected by the mixing coefficient selector is located, and the regression equation determined by the regression equation determiner.

The calibration curve creation device of this embodiment enables the independent component matrix, the target component ordinal number and the regression equation to be stored in the storage unit.

According to a third aspect of the invention, there is provided a target component determination device configured to determine content of a target component contained in a test subject. The target component determination device comprises: a test subject observation data acquirer configured to obtain observation data of the test subject; a calibration data acquirer configured to obtain calibration data including at least an independent component corresponding to the target component; a mixing coefficient calculator configured to determine a mixing coefficient corresponding to the target component with respect to the test subject, based on the obtained observation data of the test subject and the obtained calibration data; and a target component calculator configured to calculate the content of the target component contained in the test subject, based on a preset constant of a regression equation and the mixing coefficient determined by the mixing coefficient calculator, the regression equation showing relationship between the mixing coefficient corresponding to the target component.

The target component determination device according to the third aspect enables the content of the target component contained in the test subject to be determined with high accuracy by obtaining only single observation data of the test subject.

According to one embodiment, there is provided the target component determination device of the third aspect, wherein the calibration data acquirer may obtain a predetermined independent component corresponding to the target component, as the calibration data, and the mixing coefficient calculator may calculate inner product of the predetermined independent component and the observation data of the test subject and set the calculated inner product to the mixing coefficient.

The target component determination device of this embodiment enables the mixing coefficient having the high correlation to the target component of the test subject to be readily determined with high accuracy.

According to another embodiment, there is provided the target component determination device of the third aspect, wherein the calibration data acquirer may obtain a plurality of independent components, which are separated from observation data with respect to each of a plurality of samples, as the calibration data, and the mixing coefficient estimator may calculate an estimated mixing matrix with respect to the test subject, based on the observation data of the test subject and the obtained plurality of independent components, and select the mixing coefficient corresponding to the target component from the estimated mixing matrix.

The target component determination device of this embodiment enables the mixing coefficient having the high correlation to the target component of the test subject to be determined with high accuracy.

The present invention may be implemented by a variety of aspects and applications, other than those described above, for example, a target component determination device configured to store a regression equation determined by the method described above, into its memory.

For example, according to one aspect of the invention, there is provided a device including at least one element among four elements, i.e., a data acquirer, a component content acquirer, an estimator, and a determiner. In other words, this device may include or may not include the data acquirer. This device may include or may not include the component content acquirer. This device may include or may not include the estimator. This device may include or may not include the determiner. The data acquirer may be configured to, for example, obtain observation data with respect to a plurality of samples for a test subject. The component content acquirer may be configured to, for example, obtain content of a target component contained in each of a plurality of samples. The estimator may be configured to, for example, estimate a plurality of independent components, which are separated from observation data with respect to each of samples, and to calculate a mixing coefficient corresponding to a target component with respect to each of samples, based on the estimated plurality of independent components. The determiner may be configured to, for example, determine a regression equation of a calibration curve, based on the obtained contents of a target component contained in a plurality of samples and the mixing coefficients of the respective samples. This device may be implemented as, for example, the calibration curve creation device but may also be implemented as any of various devices other than the calibration curve creation device. This aspect has at least one of advantageous effects including size reduction of the device, cost saving, resource saving, easy manufacturing, and improved convenience. Part or all of the technical matters according to the respective embodiments of the calibration curve creation device described above may be applied to this device.

For example, according to one aspect of the invention, there is provided a device including at least one element among four elements, i.e., a first data acquirer, a second data acquirer, a first calculator, and a second calculator. In other words, this device may include or may not include the first data acquirer. This device may include or may not include the second data acquirer. This device may include or may not include the first calculator. This device may include or may not include the second calculator. The first data acquirer may be configured to, for example, obtain observation data of the test subject. The second data acquirer may be configured to, for example, obtain calibration data including at least an independent component corresponding to a target component. The first calculator may be configured to, for example, determine a mixing coefficient corresponding to a target component with respect to a test subject, based on the obtained observation data of the test subject and the obtained calibration data. The second calculator may be configured to, for example, calculate the content of a target component contained in the test subject, based on a preset constant of a regression equation, which shows relationship between a mixing coefficient corresponding to a target component and the content of the target component, and the mixing coefficient. This device may be implemented as, for example, the target component determination device but may also be implemented as any of various devices other than the target component determination device. This aspect has at least one of advantageous effects including size reduction of the device, cost saving, resource saving, easy manufacturing, and improved convenience. Part or all of the technical matters according to the respective embodiments of the target component determination device described above may be applied to this device.

### BRIEF DESCRIPTION OF THE DRAWINGS

FIG. 1 is a flowchart showing a method according to one embodiment of the invention;

FIG. 2 is a graph showing variations in spectral reflectivity against the wavelength of light with respect to an identical type of green vegetables having different degrees of freshness;

FIG. 3A illustrates a personal computer and its peripheral devices used at Step 4 and Step 5;

FIG. 3B is a functional block diagram of a device used at Step 4 and Step 5;

FIG. 4 schematically illustrates a set of measurement data stored in a hard disk drive;

FIG. 5 is a flowchart showing a procedure of mixing coefficient estimation process performed by a CPU;

FIG. 6 illustrates an estimated mixing matrix Â;

FIG. 7 illustrates one example of scatter diagram having high correlation;

FIG. 8 illustrates another example of scatter diagram having low correlation;

FIG. 9 is a flowchart showing a procedure of regression equation determination process performed by the CPU;

FIG. 10 is a functional block diagram showing the structure of a device used for determination of a target component; and

FIG. 11 is a flowchart showing a procedure of target component determination process performed by the CPU.

### DESCRIPTION OF THE PREFERRED EMBODIMENTS

The invention is described in detail with reference to some embodiments. One embodiment of the invention relates to a method of creating a calibration curve used to determine the amount of chlorophyll contained in a green vegetable from a spectrum of spectral reflectivity of the green vegetable obtained as observed data. The green vegetable may be, for example, spinach, Japanese mustard spinach (komatsuna) or green pepper.

### A. Calibration Curve Creation Method

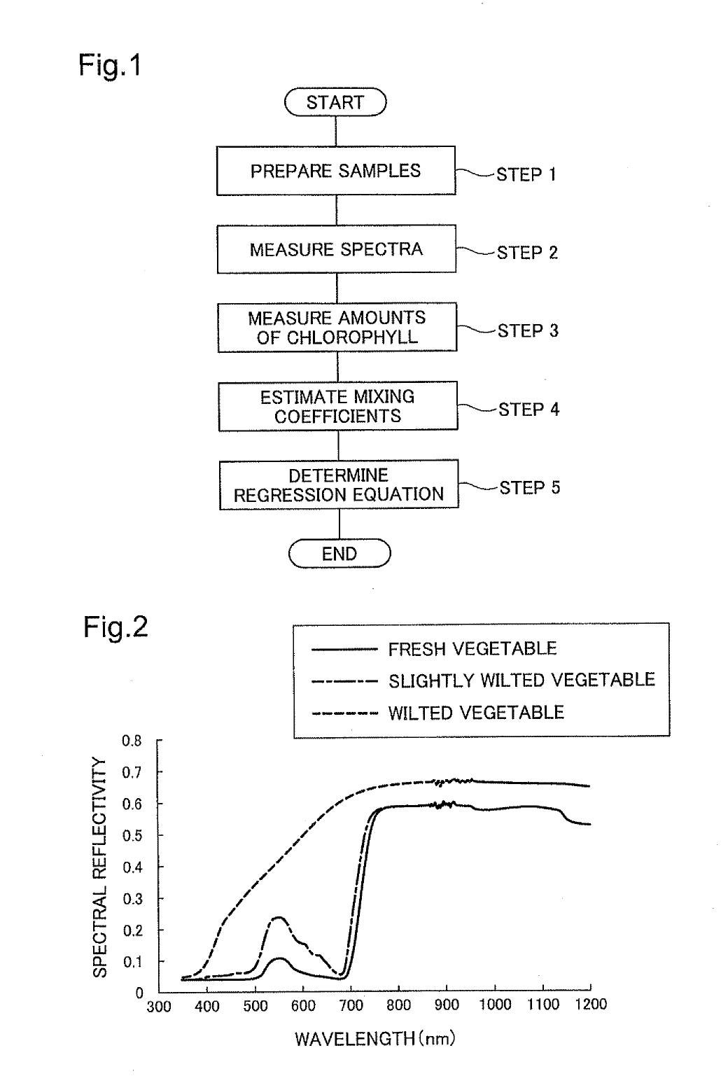

FIG. 1 is a flowchart showing a calibration curve creation method according to one embodiment of the invention. As illustrated, this calibration curve creation method includes five steps, i.e., Step 1 to Step 5. Steps 1 to 5 are performed in this sequence and are described below sequentially.

[Step 1] Step 1 is preparation step performed by the operator or the user. The operator provides or prepares a plurality of the same type of green vegetable (for example, spinach) having different degrees of freshness as samples. This embodiment uses a number “n” of samples, where n is an integer of not less than 2.
[Step 2] Step 2 is spectral measurement step performed by the operator to measure spectra with a spectral measurement device. The operator measures the plurality of samples provided at Step 1 with the spectral measurement device, so as to obtain the spectra of spectral reflectivity for the respective samples. The spectral measurement device is a known device configured to measure the spectrum of a measurement object by making the light from the measurement object pass through a spectroscope and receiving the spectrum output from the spectroscope on an imaging plane of an imaging element. There is a relationship between the spectrum of spectral reflectivity and the absorbance spectrum shown by Equation (1) given below:

[Absorbance]=−log₁₀ [Reflectivity] (1)

The measured spectrum of spectral reflectivity is converted into the absorbance spectrum according to Equation (1). Such conversion to the absorbance is based on the requirement of the linearity for the mixed signals to be analyzed by independent component analysis (described later). The absorbance holds the linearity according to the Beer-Lambert law. The absorbance spectrum may be measured, instead of the spectral reflectivity at Step 2. Absorbance distribution data representing the absorbance-wavelength characteristic of the measurement object is output as the measurement result. This absorbance distribution data is also referred to as “spectral data.”

More specifically, the operator takes aim at a specific location of each sample and measures the spectrum at the specific location at Step 2. The specific location may be any part of each sample but preferably has the degree of freshness that is not significantly different from the freshness of the overall sample. For example, when one sample has a portion with extremely poor freshness, the specific location should be other than the portion with extremely poor freshness.

FIG. 2 is a graph showing variations in spectral reflectivity against the wavelength of light with respect to the same type of green vegetables having different degrees of freshness. As illustrated, the fresh vegetable, the slightly wilted vegetable and the wilted vegetable have different spectral shapes. The fresh vegetable or the slightly wilted vegetable has an abrupt decrease in spectral reflectivity at about 700 nm and low spectral reflectivity in the wavelength range of or below 700 nm. This is ascribed to absorption of light by chlorophyll at the wavelengths of or below 700 nm. The wilted vegetable, on the other hand, has decreasing chlorophyll and thereby significantly higher spectral reflectivity in the wavelength range of or below 700 nm, compared with the fresh vegetable and the slightly wilted vegetable. The freshness of the green vegetable affects the spectral shape. The spectrum of each sample is accordingly measured at Step 2.

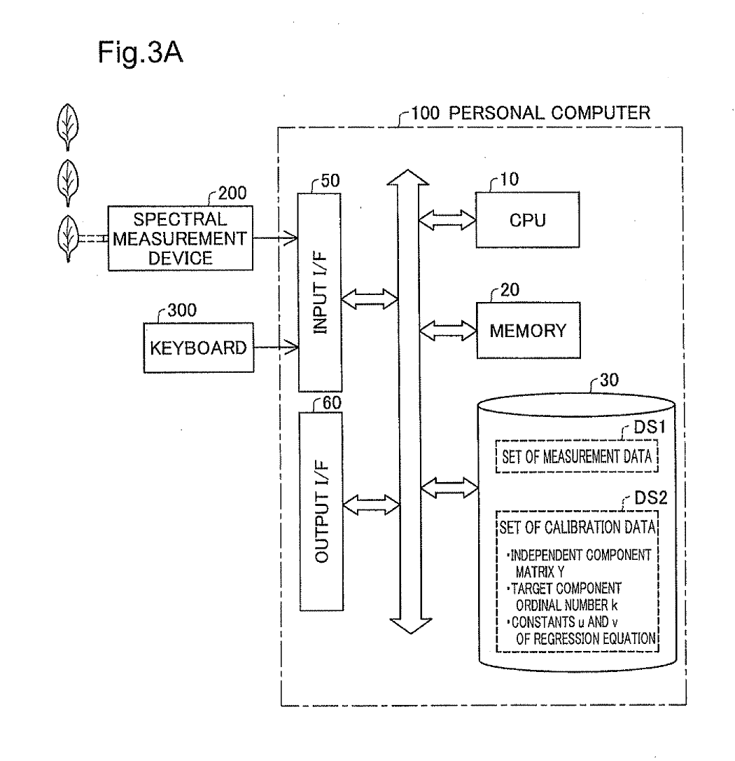

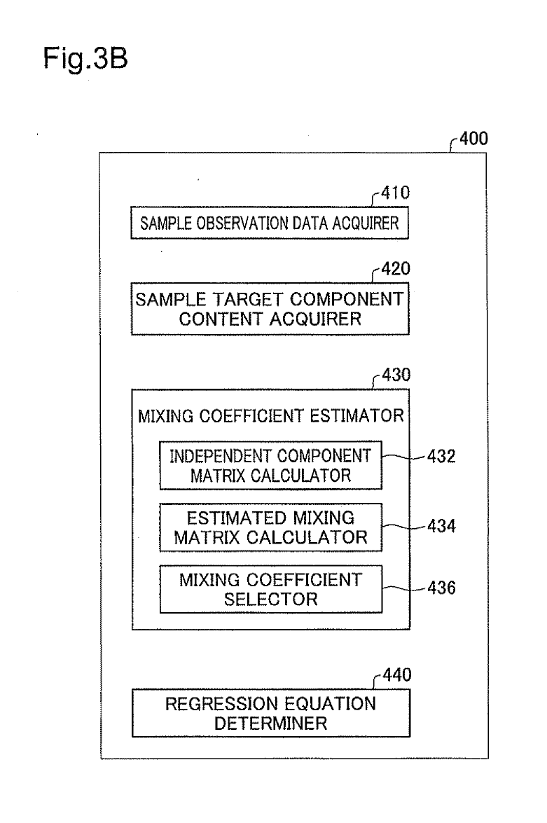

The spectrum of spectral reflectivity or the absorbance spectrum may not necessarily be directly measured with a spectroscope but may be estimated from another measurement parameter. For example, each sample may be observed with a multiband camera, and the spectrum of spectral reflectivity or the absorbance spectrum may be estimated from the obtained multiband image. For example, the method described in JP 2001-99710A may be employed for such estimation.

[Step 3] Step 3 is chlorophyll amount measurement step performed by the operator. The operator chemically analyzes each of the plurality of samples provided at Step 1 to measure the amount of chlorophyll as the content of the target component contained in each sample. More specifically, the operator sets a specific location in each sample, extracts chlorophyll as the target component from the specific location, and measures the amount of extracted chlorophyll. The “specific location” may be any part of the sample but is preferably identical with the specific location set for the spectral measurement at Step 2.
[Step 4] Step 4 is mixing coefficient estimation step performed by a personal computer (personal computer 100 in this embodiment). FIG. 3A illustrates the personal computer 100 and its peripheral devices used at Step 4 and Step 5 (described later). As illustrated, the personal computer (hereinafter referred to as “computer”) 100 is electrically connected with a spectral measurement device 200 and a keyboard 300.

The computer 100 is a known apparatus including a CPU 10 configured to execute computer programs (hereinafter referred to as “programs”) to perform various series of processing and controls, a memory 20 (storage unit) as the location to save data, a hard disk drive 30 configured to store programs, data and information, an input interface 50 and an output interface 60.

FIG. 3B is a functional block diagram of a device 400 used at Step 4 and Step 5. This device 400 includes a sample observation data acquirer 410, a sample target component content acquirer 420, a mixing coefficient estimator 430 and a regression equation determiner 440. The mixing coefficient estimator 430 includes an independent component matrix calculator 432, an estimated mixing matrix calculator 434 and a mixing coefficient selector 436. The sample observation data acquirer 410 and the sample target component content acquirer 420 may be implemented, for example, by the CPU 10 of FIG. 3A in cooperation with the input I/F 50 and the memory 20. The mixing coefficient estimator 430, i.e., the independent component matrix calculator 432, the estimated mixing matrix calculator 434 and the mixing coefficient selector 436 may be implemented, for example, by the CPU 10 of FIG. 3A in cooperation with the memory 20. The regression equation determiner 440 may be implemented, for example, by the CPU 10 of FIG. 3A in cooperation with the memory 20. These functional blocks may also be implemented by another specific device different from the personal computer 100 shown in FIG. 3A or a hardware circuit.

The spectral measurement device 200 shown in FIG. 3A is used at Step 2. The computer 100 obtains an absorbance spectrum from the spectral distribution measured by the spectral measurement device 200 at Step 2, via the input I/F 50 as spectral data (this operation corresponds to that of the sample observation data acquirer 410 shown in FIG. 3B). The computer 100 also obtains the amount of chlorophyll measured at Step 3 through the operator's operation of the keyboard 300 via the input I/F 50 (this operation corresponds to that of the sample target component content acquirer 420 shown in FIG. 3B). The amount of chlorophyll measured at Step 3 may be input into the computer 100 as the weight of chlorophyll per unit weight (for example, per 100 grams) at the specific location as the object area of measurement of chlorophyll. Alternatively the amount of chlorophyll measured at Step 3 may be input as the absolute weight (grams) into the computer 100.

As the result of obtaining the spectral data and the amount of chlorophyll, a data set DS1 including the spectral data and the amount of chlorophyll (hereinafter referred to as “set of measurement data”) is stored in the hard disk drive 30 of the computer 100.

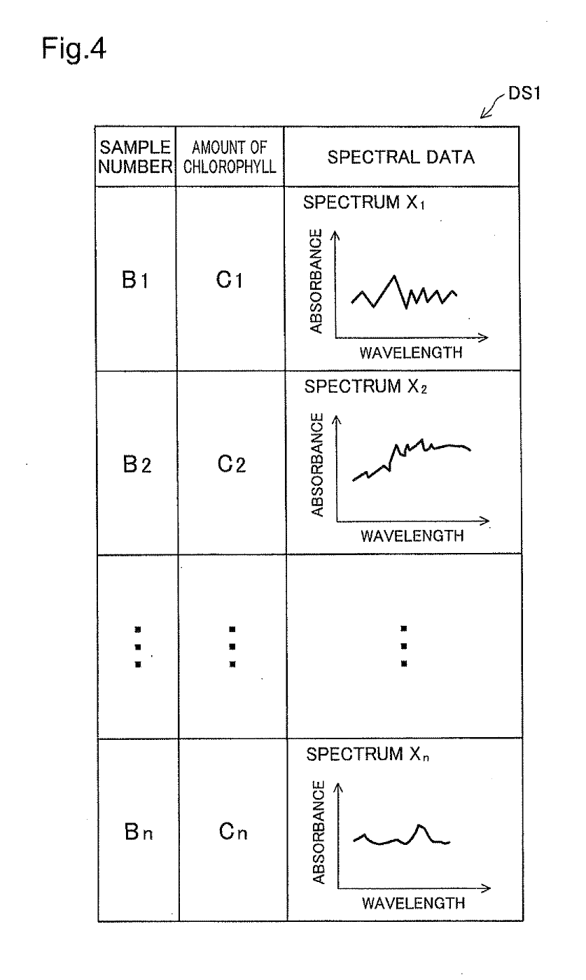

FIG. 4 schematically illustrates the set of measurement data DS1 stored in the hard disk drive 30. The set of measurement data DS1 has the data structure including: sample numbers B₁, B₂, . . . , Bₙ used to identify the plurality of samples provided at Step 1; the amounts of chlorophyll C₁, C₂, . . . , Cₙ of the respective samples; and spectral data X₁, X₂, . . . , Xₙ of the respective samples. In the set of measurement data DS1, each of the amounts of chlorophyll C₁, C₂, . . . , Cₙ and each of the spectral data X₁, X₂, . . . , Xₙ are correlated to the corresponding one of the sample numbers B₁, B₂, . . . , Bₙ for identification of the respective samples.

The CPU 10 loads a predetermined program stored in the hard disk drive 30 onto the memory 20, and executes it to estimate mixing coefficients as the operation at Step 4. The predetermined program may be downloaded from outside via a network, such as the Internet. At step 4, the CPU 10 serves as the mixing coefficient estimator 430 shown in FIG. 3B.

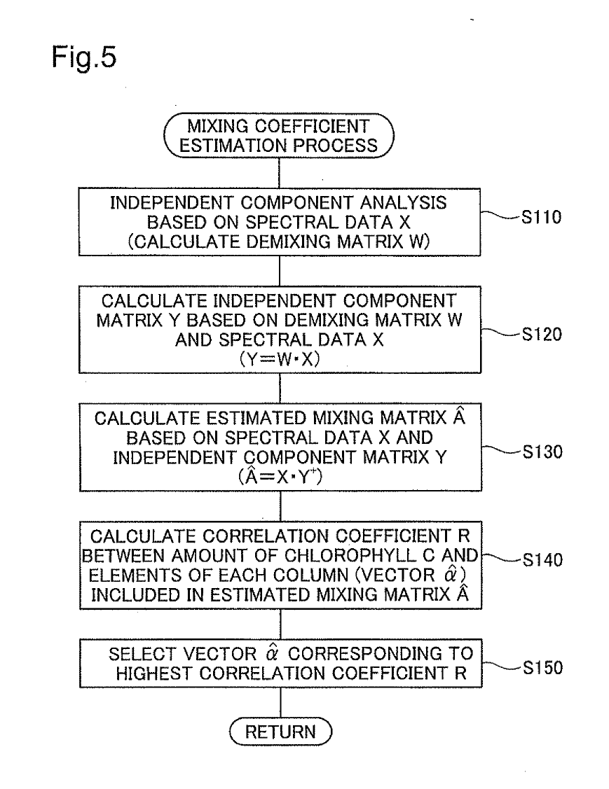

FIG. 5 is a flowchart showing a procedure of mixing coefficient estimation process performed by the CPU 10. On the start of the processing flow, the CPU 10 first performs independent component analysis (step S110).

The independent component analysis (ICA) is one technique of multidimensional signal processing. The ICA technique observes mixed signals of independent signals under a number of different conditions and separates the independent original signals based on the results of the observations. The independent component analysis regards the spectral data obtained at Step 2 as that of a mixture of a number “m” of (unknown) independent components including chlorophyll, and thereby it is possible to estimate the spectra of the respective independent components from the spectral data (observed data) obtained at Step 2.

The independent component analysis is described in detail. It is here assumed that spectra S of the number “m” of unknown components (sources) (hereinafter these spectra may be referred to as “unknown components”) are given by a vector according to Equation (2) below and that the number “n” of spectral data X obtained at Step 2 are given by a vector according to Equation (3) below. Each of the elements (S₁, S₂, . . . , Sₘ) included in Equation (2) is a vector (spectrum). For example, the element S₁ may be expressed by Equation (4) below. Each of the elements (X₁, X₂, . . . , Xₙ) included in Equation (3) is also a vector. For example, the element X₁ may be expressed by Equation (5) below. The subscript “1” represents the number of wavelength bands as the objects of spectral measurement. The number “m” of the elements in the spectra S of the unknown components is an integer of or above 1 and is determined in advance empirically or experimentally depending on the type of the sample (in this example, spinach).

S=[S₁,S₂, . . . ₘ]^{T}: (2)

X=[X₁,X₂, . . . ₙ,]^{T}: (3)

S₁={S₁₁,S₁₂, . . . ,S₁ₗ} (4)

X₁={X₁₁,X₁₂, . . . ,X₁ₗ} (5)

The unknown components are assumed to be statistically independent from one another. These unknown components S and the spectral data X hold a relationship according to Equation (6) given below.

X=A·S (6)

A in Equation (6) represents a mixing matrix and may also be expressed by Equation (7) below. Matrices are generally represented as bold capital letters in this specification.

$$A = ( \begin{matrix}{a}_{11} & … & {a}_{1 m} \\ ⋮ & ⋱ & ⋮ \\ {a}_{n 1} & … & {a}_{n m}\end{matrix} ) \qquad ( 7 )$$

Each mixing coefficient aᵢⱼ included in the mixing matrix A represents the degree of contribution of an unknown component Sⱼ (j=1 to m) to spectral data Xᵢ (i=1 to n) as the observed data.

When the mixing matrix A is known, the least square solutions of the unknown components S are readily determined by an inner product A⁺·X using the pseudo inverse matrix A⁺ of the mixing matrix A. According to this embodiment, however, the mixing matrix A is unknown, so that the unknown components S and the mixing matrix A should be estimated from only the observed data X. The procedure of this embodiment accordingly uses an m×n demixing matrix W to calculate a matrix Y representing the spectra of the independent components (hereinafter referred to as “independent component matrix”) from only the observed data X as shown by Equation (8) below. Any of various algorithms, such as Infomax, FastICA (Fast Independent Component Analysis) and JADE (Joint Approximate Diagonalization of Eigenmatrices) may be employed to determine the demixing matrix W in Equation (8).

Y=W·X (8)

The independent component matrix Y corresponds to the estimated values of the unknown components S. Equation (9) given below is accordingly obtained and is rewritten as Equation (10) given below.

X=Â·Y (9)

Â=X·Y⁺ (10)

wherein Â represents an estimated mixing matrix, and Y+ represents a pseudo inverse matrix of Y.

The estimated mixing matrix Â may be expressed as Equation (11) given below.

$$\hat{A} = ( \begin{matrix}{\hat{a}}_{11} & … & {\hat{a}}_{1 m} \\ ⋮ & ⋱ & ⋮ \\ {\hat{a}}_{n 1} & … & {\hat{a}}_{n m}\end{matrix} ) \qquad ( 11 )$$

At step S110 in FIG. 5, the CPU 10 performs the processing to determine the demixing matrix W. More specifically, the CPU 10 determines the demixing matrix W according to one of the algorithms mentioned above, Infomax, FastICA and JADE using the spectral data X of the respective samples obtained at Step 2 and stored in advance in the hard disk drive 30 as the input. The spectral data X used in the independent component analysis is required to be normalized. It is accordingly preferable to perform normalization at either Step 2 or Step 3 (i.e., prior to Step 4). The normalization may, for example, subtract the mean value of the spectral data X (mean value of X₁ to Xₙ) of the whole set of samples from the spectral data X (e.g., Xᵢ) of each sample and divide the result of subtraction by the standard deviation of the spectral data X.

After the analysis at step S110, the CPU 10 calculates the independent component matrix Y from the demixing matrix W and the spectral data X of the respective samples obtained at Step 2 and stored in advance in the hard disk drive 30 (step S120). This calculation is equivalent to the operation according to Equation (8) given above. During the processing at steps S110 and S120, the CPU 10 serves as the independent component matrix calculator 432 shown in FIG. 3B.

The CPU 10 subsequently calculates the estimated mixing matrix Â from the spectral data X of the respective samples stored in advance in the hard disk drive 30 and the independent component matrix Y calculated at step S120(step S130). This calculation is equivalent to the operation according to Equation (10) given above.

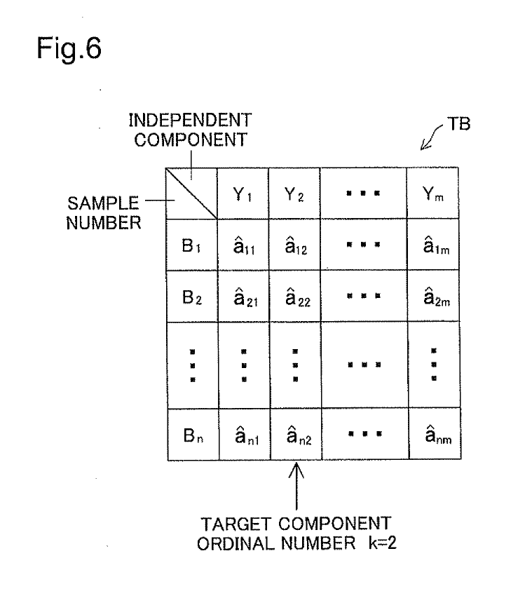

FIG. 6 illustrates the estimated mixing matrix Â. As illustrated, a table TB shows the sample numbers B₁, B₂, . . . , Bₙ in the vertical direction and the respective elements of the independent component matrix Y (hereinafter referred to as “independent component element”) Y₁, Y₂, . . . , Yₘ in the lateral direction. The respective elements in the table TB defined by the sample number Bi (i=1 to n) and the independent component element Yj (j=1 to m) are identical with the coefficients âᵢⱼ included in the estimated mixing matrix Â (see Equation (11)). As understood from this table TB, the coefficients âᵢⱼ included in the estimated mixing matrix Â show the percentages of the respective independent component elements Y₁, Y₂, . . . , Yₘ contained in each sample. A target component ordinal number k illustrated in FIG. 6 will be described later. During the processing at step S130, the CPU 10 functions as the estimated mixing matrix calculator 434 shown in FIG. 3B.

The series of processing to step S130 determines the estimated mixing matrix Â or more specifically determines the coefficients (estimated mixing coefficients) âᵢⱼ included in the estimated mixing matrix Â. The processing flow then goes to step S140.

At step S140, the CPU 10 determines the correlation (degree of similarity) between the amounts of chlorophyll C₁, C₂, . . . , Cₙ measured at Step 3 and the elements of each column (hereinafter referred to as vector \hat{α}) included in the estimated mixing matrix Â calculated at step S130. More specifically, the CPU 10 determines the correlation between the amount of chlorophyll C (C₁, C₂, . . . , Cₙ) and the vector \hat{α}₁ of the first column (â₁₁, â₂₁, . . . , âₙ₁) and subsequently determines the correlation between the amount of chlorophyll C (C₁, C₂, . . . , Cₙ) and the vector \hat{α}₂ of the second column (â₁₂, â₂₂, . . . , âₙ₂). The CPU 10 sequentially determines the correlations of the respective columns to the amount of chlorophyll C in this manner and lastly determines the correlation between the amount of chlorophyll C (C₁, C₂, . . . , Cₙ) and the vector \hat{α}ₘ of the m-th column (â₁ₘ, âₘ₂, . . . , âₙₘ).

This correlation is specified by a correlation coefficient R according to Equation (12) given below. This correlation coefficient R is called Pearson's product-moment correlation coefficient.

$$R = \frac{{\sum }_{i = 1}^{n} ( {C}_{1} - \overline{C} ) ( {\hat{a}}_{ik} - \overline{{\hat{α}}_{k}} )}{\sqrt{{\sum }_{i = 1}^{n} {( {C}_{1} - \overline{C} )}^{2}} \sqrt{{\sum }_{i = 1}^{n} {( {\hat{a}}_{ik} - \overline{{\hat{α}}_{k}} )}^{2}}} \qquad ( 12 )$$

wherein C̅ and \hat{ā}{circumflex over (āₖ respectively represent the mean value of the amount of chlorophyll and the mean value of the vector \hat{α}ₖ.

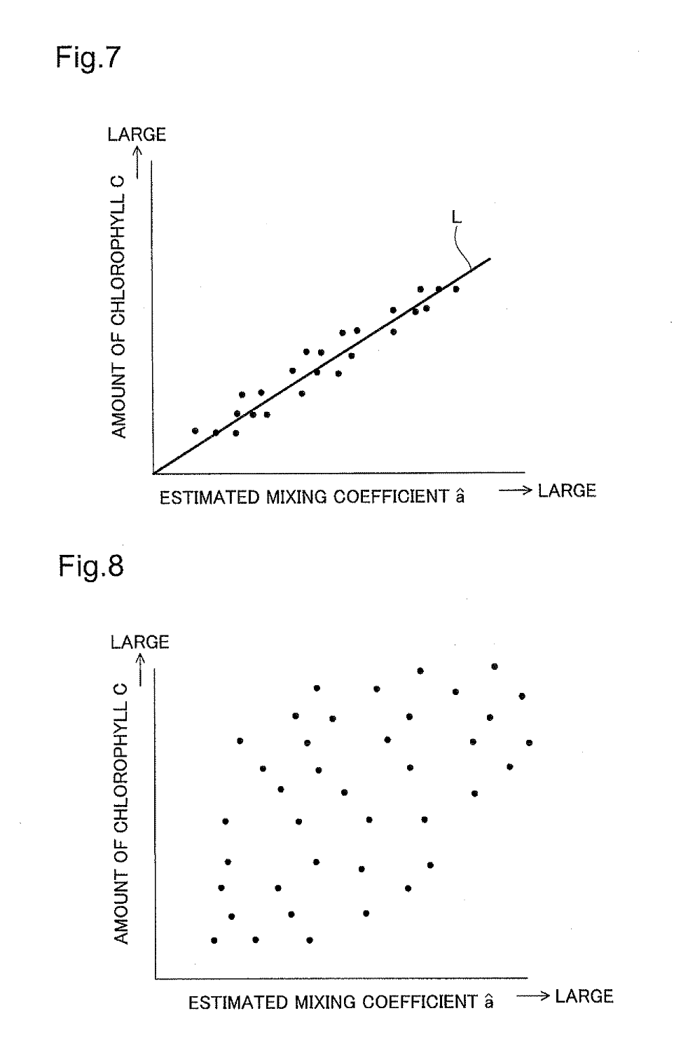

FIG. 7 illustrates a scatter diagram. The illustrated scatter diagram shows the amount of chlorophyll C as ordinate and the coefficient â of the estimated mixing matrix Â (â will be hereinafter referred to as estimated mixing coefficient) as abscissa. The respective plot points are defined by the combinations of the respective elements C₁, C₂, . . . , Cₙ as the amount of chlorophyll C and the estimated mixing coefficients â₁ⱼ, â₂ⱼ, . . . , âₙⱼ (j=1 to m) included in the vector \hat{α} in the vertical direction of the estimated mixing matrix Â. In the illustrated example, the respective plot points are approximately aligned and are relatively close to a straight line L. In this case, there is a high correlation between the amount of chlorophyll C and the estimated mixing coefficient â. When there is a low correlation between the amount of chlorophyll C and the estimated mixing coefficient â, on the contrary, the respective plot points are not aligned at all but are scattered as illustrated in the scatter diagram of FIG. 8. In other words, the higher correlation between the amount of chlorophyll C and the estimated mixing coefficient â has the higher tendency that the respective plot points are approximately aligned. The correlation coefficient R shown in Equation (12) indicates the tendency that the respective plot points are approximately aligned.

As the result of step S140 in FIG. 5, the correlation coefficient Rⱼ (j=1, 2, . . . , m) of each independent component (independent component spectrum) Yj is obtained. The CPU 10 subsequently identifies a correlation coefficient Rj of the highest correlation among the correlation coefficients Rj obtained at step S140, i.e., a correlation coefficient Rj closest to the value “1”. According to the scatter diagram, the correlation coefficient Rj having the plot points closest to the straight line is identified here. The CPU 10 then selects a column vector \hat{α} corresponding to the highest correlation coefficient R from the estimated mixing matrix Â (step S150).

The selection at step S150 selects one column among the plurality of columns according to the table TB shown in FIG. 6. The elements of the selected column are mixing coefficients of the independent component corresponding to chlorophyll as the target component. A vector \hat{α}ₖ (â₁ₖ, â₂ₖ, . . . , âₙₖ) is obtained as the result of the selection, wherein k is an integer in the range of 1 to m. The value of k is temporarily stored in the memory 20 as the target component ordinal number indicating what ordinal number of the independent component is the target component. The elements â₁ₖ, â₂ₖ, . . . , âₙₖ included in this vector \hat{α}ₖ correspond to the “mixing coefficients corresponding to the target component” described in Summary section. In the illustrated example of FIG. 6, the target component ordinal number k=2 indicates a column vector \hat{α}₂=(â₁₂, â₂₂, . . . , âₙ₂) corresponding to the independent component Y₂. In the specification hereof, the term “ordinal number” means the “value representing the location in the matrix”. During the processing at steps S140 and S150, the CPU 10 serves as the estimated coefficient selector 436 shown in FIG. 3B. After the selection at step S150, the CPU 10 terminates this mixing coefficient estimation process. On completion of Step 4, the calibration curve creation method proceeds to Step 5.

[Step 5] Step 5 is regression equation determination step performed by the computer 100, like Step 4. The computer 100 determines the regression equation of the calibration curve at Step 5. According to another embodiment, a different computer from the computer 100 may perform the operation of Step 5 with transmission of data obtained at Steps 1 to 4.

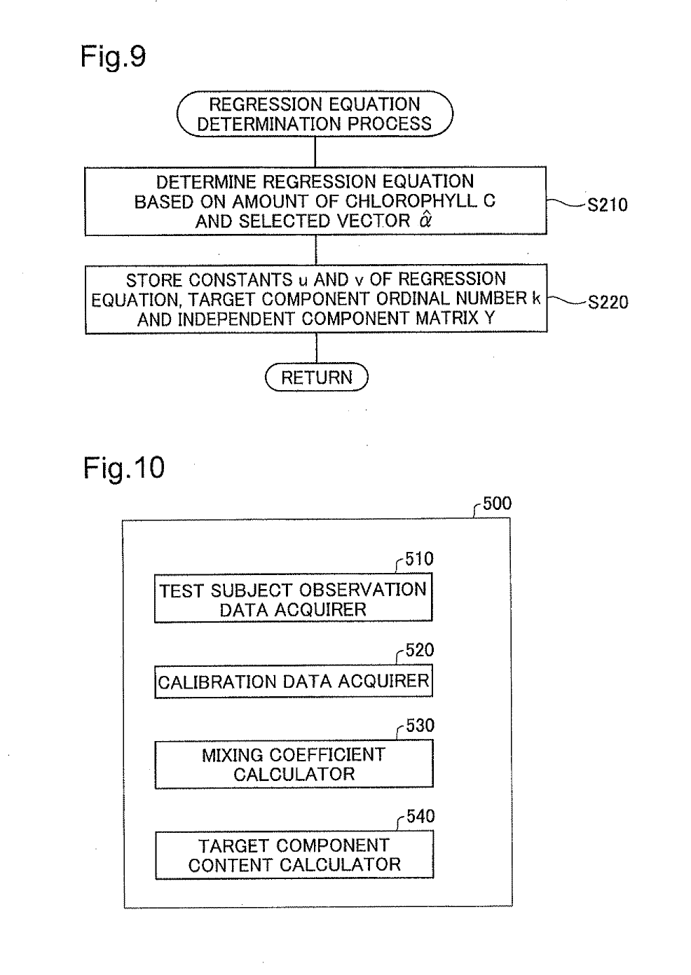

FIG. 9 is a flowchart showing a procedure of regression equation determination process performed by the CPU 10 of the computer 100. On the start of the processing flow, the CPU 10 determines a regression equation F, based on the amount of chlorophyll C (C₁, C₂, . . . , Cₙ) measured at Step 3 and the vector \hat{α}ₖ (â₁ₖ, â₂ₖ, . . . , âₙₖ) selected at step S150 (step S210). When the scatter diagram shown in FIG. 7 has the highest correlation, the straight line L in the scatter diagram corresponds to the regression equation F. The method of determining the regression equation is known in the art and is not described in detail here. For example, the least square method may be employed to make the distances (deviations) of the respective plot points from the straight line L approach zero. The regression equation F is expressed by Equation (13) given below. Constants u and v included in Equation (13) are determined at step S210.

F:C=u\hat{α}+v (13)

After step S210, the CPU 10 stores the constants u and v of the regression equation F determined at step S210, the target component ordinal number k selected at step S150 (FIG. 6), and the independent component matrix Y calculated at step S120 in the mixing coefficient estimation process (FIG. 5), as a set of calibration data DS2 into the hard disk drive 30 (step S220). The CPU 10 subsequently goes to Return and terminates this regression equation determination process. This obtains the regression equation of the calibration curve and concludes the calibration curve creation method shown in FIG. 1. During the processing at steps S210 and S220, the CPU 10 serves as the regression equation determiner 440 shown in FIG. 3B.

### B. Target Component Determination Method

The following describes the method of determining the target component contained in a test subject. The test subject contains the same components as those contained in the sample used for creating the calibration curve. The target component determination method is performed by a computer, which may be identical with or different from the computer 100 used in the calibration curve creation method described above.

FIG. 10 is a functional block diagram showing the structure of a device 500 used for determination of the target component. This device 500 includes a test subject observation data acquirer 510, a calibration data acquirer 520, a mixing coefficient calculator 530 and a target component content calculator 540. The test subject observation data acquirer 510 may be implemented, for example, by the CPU 10 of FIG. 3A in cooperation with the input I/F 50 and the memory 20. The calibration data acquirer 520 may be implemented, for example, by the CPU 10 of FIG. 3A in cooperation with the memory 20 and the hard disk drive 30. The mixing coefficient calculator 530 and the target component content calculator 540 may be implemented, for example, by the CPU 10 of FIG. 3A in cooperation with the memory 20. According to this embodiment, the computer serving as the respective functional blocks shown in FIG. 10 is identical with the computer 100 used for creating the calibration curve described above. The set of calibration data DS2 described above is stored in the storage unit, such as the hard disk drive 30.

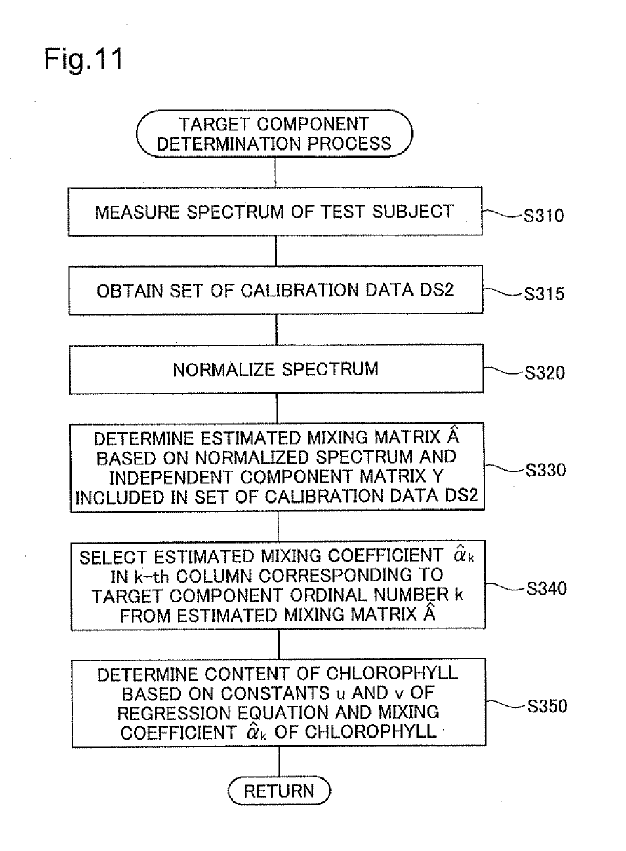

FIG. 11 is a flowchart showing a procedure of target component determination process performed by the CPU 10 of the computer 100. The CPU 10 loads a predetermined program stored in the hard disk drive 30 onto the memory 20, and executes it to implement this target component determination process. On the start of the processing flow, the CPU 10 causes a spectral measurement device to measure a green vegetable as a test subject (step S310). The measurement at step S310 is performed in a similar manner to that of Step 2 described above, so as to give an absorbance spectrum Xp of the test subject. The spectral measurement device used in this target component determination process is preferably the same model as that of the spectral measurement device used for creating the calibration curve in order to reduce the potential error and is more preferably the actual machine or the same machine in order to minimize the potential error. Like Step 2 of FIG. 1, the spectrum of spectral reflectivity or the absorbance spectrum may not necessarily be directly measured with a spectroscope but may be estimated from other measurement values. The absorbance spectrum Xp of a test subject is expressed by a vector according to Equation (14) given below.

Xₚ={Xₚ₁,Xₚ₂, . . . ,Xₚₗ} (14)

During the processing at step S310, the CPU 10 serves as the test subject observation data acquirer 510 shown in FIG. 10. The CPU 10 subsequently obtains the set of calibration data DS2 from the hard disk drive 30 and stores the obtained set of calibration data DS2 into the memory 20 (step S315). During the processing at step S315, the CPU 10 serves as the calibration data acquirer 520 shown in FIG. 10.

After step S315, the CPU 10 normalizes the absorbance spectrum Xp of the test subject obtained at step S310 (step S320). This normalization subtracts the mean value of the entire spectrum from each individual value in the spectrum and divides the result of subtraction by the standard deviation.

The CPU 10 subsequently determines an estimated mixing matrix Â of the test subject, based on the independent component matrix Y included in the set of calibration data DS2 and the normalized spectrum obtained at step S320(step S330). More specifically, the CPU 10 performs the operation according to Equation (10) given above, which determines an inverse matrix (pseudo inverse matrix) Y⁺ of the independent component matrix Y included in the set of calibration data DS2 and multiplies the normalized spectrum obtained at step S320 by the pseudo inverse matrix Y⁺ to determine the estimated mixing matrix Â.

As shown by Equation (15) given below, the estimated mixing matrix Â determined in the target component determination process is a row vector (1×m matrix) of the mixing coefficients corresponding to the respective independent components. After step S330, the CPU 10 reads the target component ordinal number k included in the set of calibration data DS2 from the hard disk drive 30, selects a mixing coefficient \hat{α}ₖ of the k-th component corresponding to the target component ordinal number k from the estimated mixing matrix Â determined at step S330, and stores the selected mixing coefficient ̂αₖ as the mixing coefficient of chlorophyll as the target component into the memory 20 (step S340). During the processing at steps S320 to S340, the CPU 10 serves as the mixing coefficient calculator 530 shown in FIG. 10.

\hat{A}=(\hat{α}₁,\hat{α}₂, . . . ,\hat{α}ₘ) (15)

The CPU 10 subsequently reads the constants u and v of the regression equation included in the set of calibration data DS2 from the hard disk drive 30 and substitutes these constants u and v and the mixing coefficient \hat{α}ₖ of chlorophyll as the target component selected at step S340 into the right side of Equation (13) given above, so as to determine a content C of chlorophyll (step S350). The content C is given as the weight of chlorophyll contained per unit weight (for example, 100 grams) of the test subject. During the processing at step S350, the CPU 10 serves as the target component content calculator 540 shown in FIG. 10. The CPU 10 goes to Return and terminates this target component determination process.

According to this embodiment, the content C (i.e., weight per unit weight) determined at step S350 is used as the amount of chlorophyll of the test subject. According to another embodiment, the content C determined at step S350 may be corrected with the normalization coefficient used in the normalization at step S320, and the corrected value may be used as the amount of chlorophyll of the test subject. A concrete procedure of this latter embodiment may multiply the determined content C by the standard deviation to give the amount of chlorophyll as the absolute weight (grams). This enables the determination of the amount of chlorophyll with the higher accuracy according to the type of the target component.

### C. Advantageous Effects of Embodiment

The calibration curve creation method of the embodiment described above determines the amount of chlorophyll with high accuracy from one spectrum as the actual observed data of a green vegetable as a test subject.

### D. Modifications

The invention is not limited to the above embodiment or its applications but various modifications and variations may be made to the embodiment without departing from the scope of the invention. Some of possible modifications are described below, wherein the like components to those of the above embodiment are expressed by the like numerical symbols and are not specifically described here.

### *Modification 1

According to the above embodiment, the test subject observation data acquirer 510 (FIG. 10) reads the set of calibration data DS2 from the hard disk drive 30 and obtains the independent component matrix Y including the independent component corresponding to the target component. The mixing coefficient calculator 530 (FIG. 10) determines the estimated mixing matrix Â of the test subject based on the absorbance spectrum of the test subject and the independent component matrix Y and selects the mixing coefficient αₐ in the k-th column corresponding to the target component ordinal number k from the estimated mixing matrix Â, so as to determine the mixing coefficient of the target component for the test subject. The present invention is, however, not limited to this procedure but may follow another procedure of sequentially performing steps (i) and (ii) described below.

(i) The procedure reads the set of calibration data DS2 stored in the hard disk drive 30 and extracts an element (independent component) Yₖ in the k-th column corresponding to the target component ordinal number k from the independent component matrix Y included in the set of calibration data DS2. This independent component Yₖ has the highest correlation to the amount of chlorophyll and corresponds to the amount of chlorophyll.

(ii) The procedure subsequently calculates the inner product of the extracted independent component Yₖ and the spectrum Xₚ of the test subject as the observation data (for example, the normalized spectrum obtained at step S320) and sets the calculated inner product as the mixing coefficient αₖ of the target component. This is equivalent to performing the operation according to Equation (16) given below.

αₖ=Xₚ·Yₖ (16)

The observation data is given as the linear sum of the independent components, and the independent components are assumed to have sufficient orthogonality. Calculating the inner product of the spectrum as the observation data and the independent component extracted as the target component from the independent component matrix laves only the value of the extracted independent component, while setting all the other elements equal to zero. This facilitates the calculation of the mixing coefficient αₖ of the target component. When the independent components do not have sufficient orthogonality, however, determining the estimated mixing matrix Â according to Equation (15) is preferred over performing the operation according to Equation (16).

The CPU 10 serves as the calibration data acquirer 520 during the processing at step (i) and as the mixing coefficient calculator 530 during the processing at step (ii). The calibration data acquirer 520 is not limited to the configuration to perform step (i) described above but may alternatively be configured to obtain the independent component Yₖ from the storage unit, such as the hard disk drive 30, which stores in advance the element (independent component) Yₖ in the k-th column corresponding to the target component ordinal number k in the independent component matrix Y. Only the independent component corresponding to the target component is required to calculate the inner product, while the other independent components are not necessary. In this case, the independent component is given as a vector, and there is no need to store the target component ordinal number.

### *Modification 2

According to the above embodiment and its modification, the test subject is a green vegetable, and the amount of chlorophyll is determined as the content of the target component. The content of chlorophyll contained in the green vegetable may be replaced by the content of any suitable target component contained in each of various test subjects, for example, oleic acid contained in meat or collagen contained in the human skin. The present invention is applicable to various test subjects and their target components by providing a plurality of samples containing the same component as the target component of the test subject and creating a calibration curve. According to the above embodiment and its modification, the absorbance spectrum is used as the observation data to determine the content of the target component. The observation data is, however, not limited to the absorbance spectrum but may be, for example, audio data as the mixture of sounds output from a plurality of sound sources. The magnitude of sound from a specific sound source may be determined by a similar procedure to that described above. The present invention is thus applicable to various observation data given in the form of signals, each including a sufficient amount of information to indicate the statistical characteristic of a corresponding signal source.

### *Modification 3

According to the above embodiment and its modifications, the mixing coefficient estimation process calculates the independent component matrix, calculates the estimated mixing matrix and selects the mixing coefficient corresponding to the target component from the estimated mixing matrix. The present invention is, however, not limited to this configuration but may be applied to any other configuration that estimates each of a plurality of independent components from the observation data of each sample and determines the mixing coefficient corresponding to the target component of each sample from the estimated independent component.

### *Modification 4

According to the above embodiment and its modifications, the calibration curve creation method actually measures the content of the target component contained in each sample. Alternatively a plurality of samples having known contents of the target component may be provided, and their contents may be input, for example, via a keyboard by the operator.

### *Modification 5

According to the above embodiment and its modifications, the number “m” of the elements in the spectra S of the unknown components is determined empirically or experimentally. The number “m” of the elements in the spectra S of the unknown components may be determined according to the information criterion, such as MDL (Minimum Description Length) or AIC (Akaike's Information Criteria). In the application using the MDL criterion, for example, the number “m” of the elements in the spectra S of the unknown components may be determined automatically by the operation from the observation data of the samples. The MDL criterion is described for example, in “Independent component analysis for noisy data—MEG data analysis, 2000”.

### *Modification 6

According to the above embodiment and its modifications, the test subject under the target component determination process contains the same components as those contained in the samples used for creation of the calibration curve. When the mixing coefficient is determined by calculating the inner product as described in Modification 1 above, the test subject may additionally contain an unknown component other than the same component as that contained in the samples used for creation of the calibration curve. The inner product of independent components is assumed to be zero, so that the inner product of the independent component corresponding to the unknown component is also thought to be zero. The effect of the unknown product is accordingly negligible in determination of the mixing coefficient by calculating the inner product.

### *Modification 7

The computer used in the above embodiment and its modifications is not limited to the personal computer but may be a dedicated device. For example, the personal computer implementing the target component determination method may be replaced by a dedicated target component determination device.

### *Modification 8

The above embodiment inputs the spectrum measured by the spectral measurement device 200 as the spectrum of spectral reflectivity with respect to each of the samples or the test subject. The present invention is, however, not limited to this embodiment. For example, one modified procedure may estimate an optical spectrum from a plurality of band images having different wavelength ranges and input the estimated optical spectrum as the spectrum of spectral reflectivity. The band mages may be obtained by capturing each of the samples or the test subject with a multiband camera including a filter having a variable transparent wavelength range.

### *Modification 9

According to the above embodiment and its modifications, the functions implemented by the software configuration may be implemented by the hardware configuration.

While the invention has been described with reference to exemplary embodiments thereof, it is to be understood that the invention is not limited only to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including fewer elements or only a single element, are also within the spirit and scope of the invention.

What is claimed is:

1. A method of creating a calibration curve for use in determining content of a target component contained in a test subject from observation data of the test subject, the method comprising the steps of:
obtaining observation data with respect to a plurality of samples of the test subject;
obtaining content of the target component contained in each of the plurality of samples;
estimating a plurality of independent components, which are separated from the observation data with respect to each of the samples, and calculating a mixing coefficient corresponding to the target component with respect to each of the samples, based on the estimated plurality of independent components; and
determining a regression equation of the calibration curve, based on the obtained contents of the target component contained in the plurality of samples and the mixing coefficients for the respective samples.

2. The method according to claim 1, wherein
the step of estimating a plurality of independent components and calculating the mixing coefficient comprises:
calculating an independent component matrix consisting of the independent components with respect to each of the samples;
calculating an estimated mixing matrix representing a set of vectors, which defines rates of independent component elements for the independent components with respect to each of the samples, from the independent component matrix; and
determining correlations of the respective vectors included in the estimated mixing matrix to the contents of the target component contained in the plurality of samples, and selecting a vector determined to have highest correlation among the set of vectors, as the mixing coefficient corresponding to the target component.

3. A calibration curve creation device configured to create a calibration curve for use in determining content of a target component contained in a test subject from observation data of the test subject, the calibration curve creation device comprising:
a sample observation data acquirer configured to obtain observation data with respect to a plurality of samples of the test subject;
a sample target component content acquirer configured to obtain content of the target component contained in each of the plurality of samples;
a mixing coefficient estimator configured to estimate a plurality of independent components, which are separated from the observation data with respect to each of the samples, and to calculate a mixing coefficient corresponding to the target component with respect to each of the samples, based on the estimated plurality of independent components; and
a regression equation determiner configured to determine a regression equation of the calibration curve, based on the obtained contents of the target component contained in the plurality of samples and the mixing coefficients for the respective samples.

4. The calibration curve creation device according to claim 3, wherein
the mixing coefficient estimator comprises:
an independent component matrix calculator configured to calculate an independent component matrix consisting of the independent components with respect to each of the samples;
an estimated mixing matrix calculator configured to calculate an estimated mixing matrix representing a set of vectors, which defines rates of independent component elements for the independent components with respect to each of the samples, from the independent component matrix; and
a mixing coefficient selector configured to determine correlations of the respective vectors included in the estimated mixing matrix to the contents of the target component contained in the plurality of samples and to select a vector determined to have highest correlation among the set of vectors, as the mixing coefficient corresponding to the target component.

5. The calibration curve creation device according to claim 4, further comprising:
a storage unit configured to store the independent component matrix calculated by the independent component matrix calculator, a target component ordinal number representing a position in the estimated mixing matrix where the mixing coefficient selected by the mixing coefficient selector is located, and the regression equation determined by the regression equation determiner.

6. A target component determination device configured to determine content of a target component contained in a test subject, the target component determination device comprising:
a test subject observation data acquirer configured to obtain observation data of the test subject;
a calibration data acquirer configured to obtain calibration data including at least an independent component corresponding to the target component;
a mixing coefficient calculator configured to determine a mixing coefficient corresponding to the target component with respect to the test subject, based on the obtained observation data of the test subject and the obtained calibration data; and
a target component calculator configured to calculate the content of the target component contained in the test subject, based on a preset constant of a regression equation and the mixing coefficient determined by the mixing coefficient calculator, the regression equation showing relationship between the mixing coefficient corresponding to the target component and the content of the target component.

7. The target component determination device according to claim 6, wherein
the calibration data acquirer obtains a predetermined independent component corresponding to the target component, as the calibration data, and
the mixing coefficient calculator calculates an inner product of the predetermined independent component and the observation data of the test subject and sets the calculated inner product to the mixing coefficient.

8. The target component determination device according to claim 6, wherein
the calibration data acquirer obtains a plurality of independent components, which are separated from observation data with respect to each of a plurality of samples, as the calibration data, and
the mixing coefficient estimator calculates an estimated mixing matrix with respect to the test subject, based on the observation data of the test subject and the obtained plurality of independent components, and selects the mixing coefficient corresponding to the target component from the estimated mixing matrix.
